(19) United States
(12) Patent Application Publication
(10) Pub. No.: US 2019/0377066 A1
(43) Pub. Date: Dec. 12, 2019

(54) TRACKING OBJECTS USING VIDEO IMAGES AND LIDAR

(71) Applicant: DSCG SOLUTIONS, INC., Chantilly, VA (US)

(72) Inventors: Kendall Belsley, Falls Church, VA (US); Richard Sebastian, Frederick, MD (US)

(21) Appl. No.: 16/431,493

(22) Filed: Jun. 4, 2019

Related U.S. Application Data
(60) Provisional application No. 62/681,475, filed on Jun. 6, 2018.

(51) Int. Cl. G01S 7/48; G01S 17/42; G01S 17/58; G01S 17/02

(52) U.S. Cl. CPC G01S 7/4808; G01S 17/023; G01S 17/58; G01S 17/42

(57) ABSTRACT

A technique of monitoring and/or tracking an object includes scanning a set of beams of electromagnetic radiation in lines over the object; obtaining data indicating a velocity of the object and position of the object out of the plane as the beam of electromagnetic radiation is scanned over the object; and performing a correction operation to produce a correction to the absolute position in the plane of the object at a later time after an initial time, the correction being based on the obtained data.

### RELATED APPLICATIONS

This application claims priority to U.S. Provisional Patent Application No. 62/681,475, filed Jun. 6, 2018, entitled “TRACKING OBJECTS USING VIDEO IMAGES AND LIDAR.”

### TECHNICAL FIELD

This description relates to systems and methods for tracking objects using video images and Light Detection And Ranging (LIDAR).

### BACKGROUND

In some known systems, objects may be tracked using a video system. Such a system may provide estimates of an absolute position of an object. Nevertheless, some such known systems may be difficult to use because latency caused by processing video data may result in inaccurate tracking information. Thus, a need exists for systems, methods, and apparatus to address the shortfalls of present technology and to provide other new and innovative features.

### BRIEF DESCRIPTION OF THE DRAWINGS

FIG. 1 is a block diagram illustrating an example LIDAR system within an electronic environment in which improved techniques described herein may be performed.

FIG. 2A is a diagram illustrating an example object being tracked within the electronic environment illustrated in FIG. 1.

FIG. 2B is a diagram illustrating the example object as tracked within the electronic environment illustrated in FIG. 1.

FIG. 2C is a diagram illustrating another example object being tracked within the electronic environment illustrated in FIG. 1.

FIG. 2D is a diagram illustrating the other example object as tracked within the electronic environment illustrated in FIG. 1.

FIG. 2E is a diagram illustrating the other example object as further tracked within the electronic environment illustrated in FIG. 1.

FIG. 3 is a flowchart illustrating an example method performed within the electronic environment illustrated in FIG. 1.

FIG. 4 is a diagram illustrating an example scan of an object within the electronic environment illustrated in FIG. 1.

FIG. 5 is a diagram illustrating an example determination of the correction of the absolute position of the object illustrated in FIG. 4.

FIG. 6 is a flow chart illustrating an example iterative process of computing the correction of the absolute position of the object within the electronic environment illustrated in FIG. 1.

### DETAILED DESCRIPTION

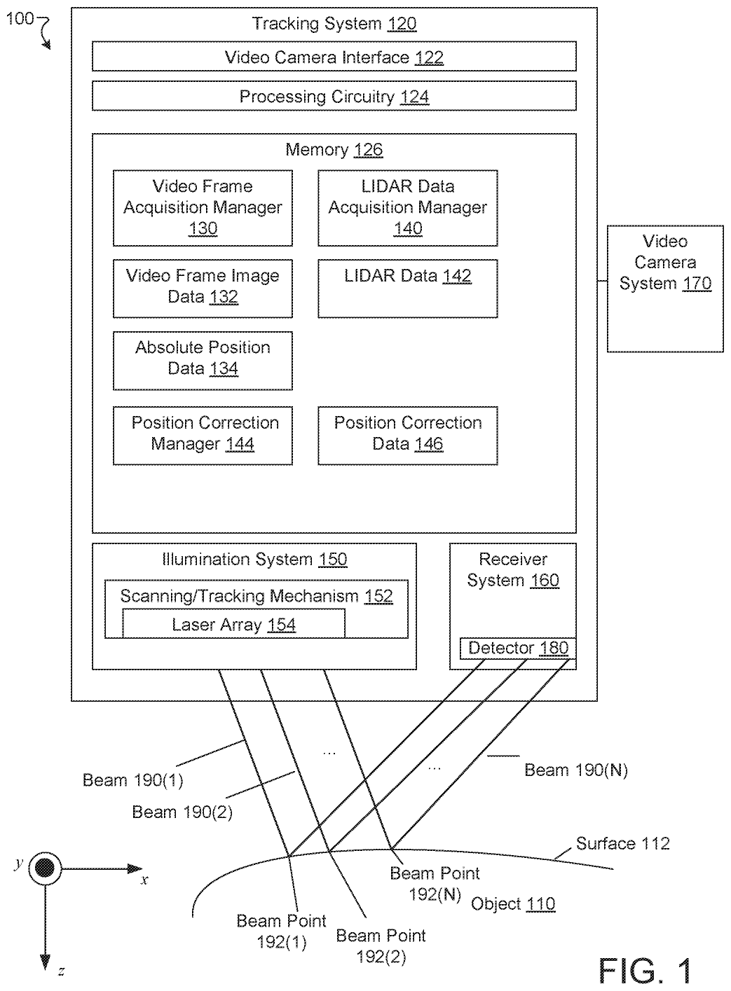

FIG. 1 is a diagram that illustrates an example electronic environment 100 in which improved techniques of tracking an object's motion are performed. The electronic environment 100 includes a tracking system 120 that is configured to track an object 110 and a video camera system 170 that is configured to measure an initial absolute position of the object 110. The tracking system 120 complements the absolute position data produced by the video camera system 170 to produce more accurate tracking of the object 110 in real time.

The object 110 is assumed herein to be a rigid body of some unknown shape. For example, the object 110 may be a human face. The object 110 is assumed to be in motion, both linear and rotational, about an arbitrary axis. It should be understood that in the electronic environment shown in FIG. 1, there is a natural axis of symmetry that is seen to be substantially normal to the orientation of the object.

Nevertheless, because the object 110 is typically in motion, the latency caused by processing video data produced by the video camera system 170 may be inaccurate. For example, suppose that the object 170 moves at about 0.5 meters per second and that the video camera system 170 produces video frames at the rate of 30 per second. The latency involved in processing video frames results in about 2 or 3 frames of delay. This latency translates into about 0.1 seconds during which the object 170 may have moved 5 cm from where the video data indicates. Accordingly, it is the primary objective of the improved techniques described herein to accurately track the movement of the object within the latency introduced by the video data processing.

As shown in FIG. 1, the tracking system 120 is a single, integrated unit that includes a video camera interface 122, processing circuitry 124, memory 126, an illumination system 150, and a receiver system 160. In some arrangements, the tracking system 120 takes the form of a handheld unit that may be pointed at the object 110. However, in other arrangements the components of the tracking system 120 may be distributed among different units (e.g., the processing circuitry 124 and memory 126 might be in a computing device separate from a handheld device that includes the illumination system 150 and the receiver system 160).

The video camera interface 122 is configured to provide a conduit for raw data from the video camera system 170 to the processing circuitry 124. In some implementations, the video camera interface is configured to perform image processing operations on the raw data to produce video image frame data 132 in a particular format, e.g., MPEG-4, H.264, and the like. In some implementations, the video camera interface 122 is configured to accept the raw data at a rate that corresponds to a frame rate of 30 frames per second; in some implementations, the frame rate may be 24 frames per second or less, or 60 frames per second or greater.

The processing circuitry 124 includes one or more processing chips and/or assemblies. The memory 126 includes both volatile memory (e.g., RAM) and non-volatile memory, such as one or more ROMs, disk drives, solid state drives, and the like. The set of processing units 124 and the memory 126 together form control circuitry, which is configured and arranged to carry out various methods and functions as described herein.

In some arrangements, one or more of the components of the tracking system 120 can be, or can include, processors configured to process instructions stored in the memory 126. For example, a video frame acquisition manager 130 (and/or a portion thereof), a LIDAR data acquisition manager 140, and a position correction manager 144 (and/or a portion thereof) shown as being included within the memory 126 in FIG. 1, can be a combination of a processor and a memory configured to execute instructions related to a process to implement one or more functions.

The video frame manager 130 is configured to receive video frame image data 132 from the video camera system 170 over the video camera interface 122. As stated above, the video frame image data 132 may be in a particular format such as MPEG-4, H.264, and the like. The video image frame data 132 may have a specified number of pixels, e.g., 320×240, 640×480, etc. In some implementations, the number of pixels may be lower or higher. In some implementations, the video frame data 132 also includes timestamps indicating times at which individual video frames were captured.

The video frame manager 130 is further configured to produce absolute position data 134 from the video frame image data 132. Because the video frame data is in two dimensions, the absolute positions of the object 110 are two-dimensional coordinates. Per the coordinate system defined in FIG. 1, the absolute position data 134 of the object derived from the video frame image data 132 is expressed as (x, y) coordinates, with x being horizontal and y being vertical in a plane, i.e. the (x,y) plane. In some implementations, each such point of the absolute position data 134 corresponds to a pixel.

The LIDAR data acquisition manager 140 is configured to produce LIDAR data 142 in response to the detector 180 receiving beams of electromagnetic (EM) radiation (e.g., laser light) reflected from the object 110 upon scanning the object. In some arrangements, the LIDAR data 142 includes position data for the object 110 along the z-axis as defined in the coordinate system in FIG. 1 (i.e., out of the (x,y) plane as discussed above) and rotational velocity data for the object 110 about the x- and y-axes as defined in the coordinate system in FIG. 1.

The position correction manager 144 is configured to generate position correction data 146 based on the LIDAR data 142. The position correction data 146 includes position correction values that are to be added to the position values of the absolute position data 134 at times between times indicated by timestamps of the video frame image data 132. In some implementations, the position correction data 146 includes a correction to the position of the object 110 in the (x,y) plane as defined in the coordinate system in FIG. 1. In some implementations, the position correction data 146 includes a correction to the position of the object 110 along the x-axis as defined in the coordinate system in FIG. 1.

The illumination system 150 is configured and arranged to produce the illumination that is reflected from the surface 112 of the object 110. As shown in FIG. 1, this illumination takes the form of multiple beams 190(1), . . . , 190(N) of radiation directed along the z-axis. The illumination system 150 includes a scanning mechanism 152, which includes a laser array 154, and an aperture 170.

The scanning/tracking mechanism 152 is configured and arranged to move the laser array 154 in a scanning and/or tracking motion. As shown in FIG. 1, the scanning/tracking mechanism 152 is configured to move each laser in the laser array 154 substantially along the x and y directions, i.e., orthogonally to the direction of the beams 190(1), . . . , 190(N). The scanning/tracking mechanism 152 moves the laser array 154 altogether, so that all movements are performed in one motion.

The laser array 154 is configured and arranged to produce an array of beams (e.g., beams 190(1), . . . , 190(N)) of laser radiation, i.e., substantially coherent, quasi-monochromatic light. In many arrangements, the laser array 154 includes a rectangular array of lasers, each producing laser radiation at some wavelength. Each laser in the rectangular array corresponds to a sample point on the surface 112 of the object 110 where the beam produced by that laser reflects off the surface 112. In some arrangements, the wavelength of the light in each beam 190(1), . . . , 190(N) produced by the laser array 154 is 1550 nm. This wavelength has the advantage of being suited to objects that are, for example, human faces. Nevertheless, other wavelengths (e.g., 1064 nm, 532 nm) may be used as well.

The receiver system 160 is configured and arranged to receive the beams reflected from the surface 112 of the object 110 and generate the displacement datasets 140(1), . . . , 140(T) from the received beams. The receiver system 160 may generate the LIDAR data 142 using any number of known techniques (e.g., heterodyne detection) and will not be discussed further. The receiver system includes a detector 180 that is configured and arranged to convert the received beams into electrical signals from which the receiver system 160 may generate the LIDAR data 142. In some arrangements, the detector 180 includes a photomultiplier tube (PMT) or an array of charge-coupled devices (CCDs).

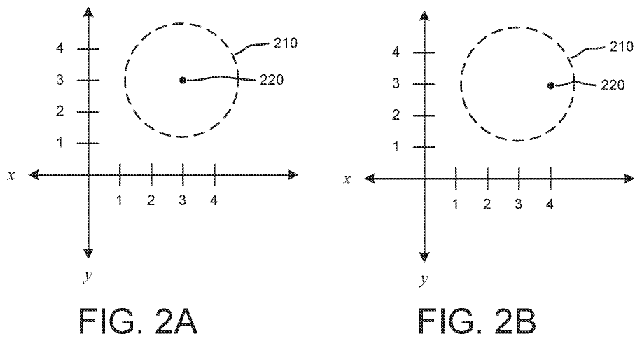

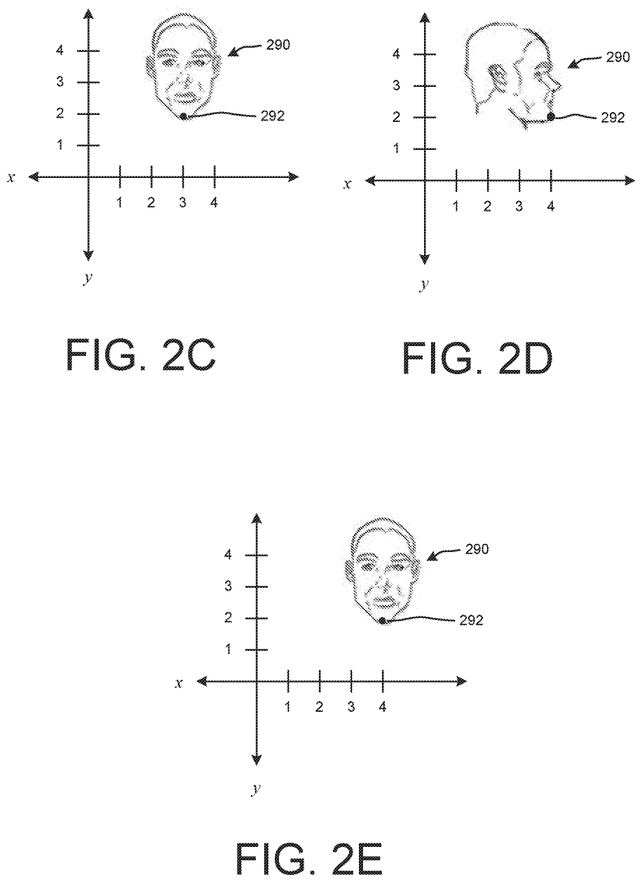

FIGS. 2A and 2B illustrate an example object 210 that may be observed by (e.g., targeted by) the tracking system 120. The object 210 may have any shape, but is represented in FIGS. 2A and 2B as a circle. In FIG. 2A, at time T1 a point 220 on the object 210 is being observed by the tracking system 120. At time T1 the point 220 is located at (3,3) in the (x,y) plane. As illustrated in FIG. 2B, at time T2 the point 220 is located at (4,3) in the (x,y) plane. The movement of the point may be the result of different types of movements of the object 80. For example, the object 220 may have moved from one location to another (translational movement) or the object 220 may have rotated (for example, about an axis parallel to the y axis of the x-y plane).

As illustrated in FIGS. 2C, 2D, and 2E a head or face 290 of an individual may be tracked or observed by the tracking system 120. Specifically, a point or location 292 of the head or face 290 may be observed. As illustrated in FIG. 2C, at time T1 the point 292 is located at (3,2) in the (x,y) plane. At time T2 the point 292 may be observed to be at (4,2). The movement of the point may be the result of different types of motion. For example, the person or individual may have rotated their head (for example, about an axis parallel to the y axis), as illustrated in FIG. 2D. Alternatively, the person or individual may have moved their head (without any rotation), as illustrated in FIG. 2E.

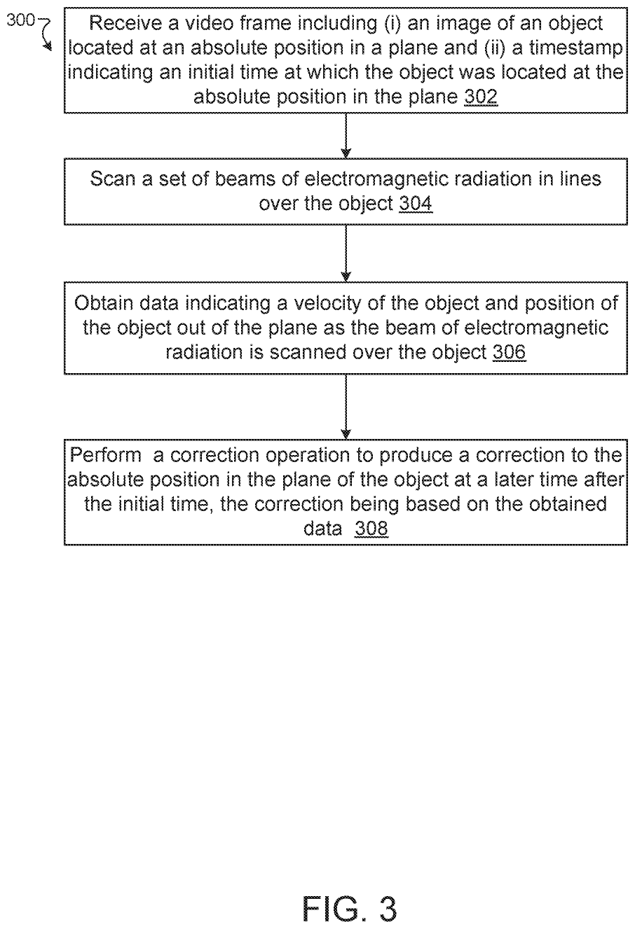

FIG. 3 illustrates an example method 300 of performing the improved technique described herein. The method 300 may be performed by constructs described in connection with FIG. 1, which can reside in memory 126 of the tracking system 120 and can be executed by the processing circuitry 124.

At 302, the tracking system 120 receives a video frame, e.g., a specified number of pixels representing a video image in the (x,y) plane at some initial time at which the object was located at the absolute position in the plane. The video frame includes (i) an image of an object located at an absolute position in a plane and (ii) a timestamp indicating the initial time.

At 304, the tracking system 120 scans a set of beams of electromagnetic radiation in lines over the object. In some arrangements, e.g., that shown in FIG. 1, the laser array 154 of the tracking system 120 produces a rectangular array of beams, e.g., 16×8, 8×8, or the like. In such arrangements, the tracking system 120 scans each beam in such array over a portion of the object in a raster fashion, e.g., in lines in the x-direction at various y-positions.

At 306, the tracking system 120 obtains data indicating a velocity of the object and position of the object out of the plane as the beam of electromagnetic radiation is scanned over the object. For a rigid body, the time-dependent linear velocity ν and time-dependent rotational velocity ω at a point r on the object 110 are related as follows:

ν=ω×r

so that linear velocity data may be derived from (3D) position data and rotational velocity data. In some arrangements, the LIDAR data 142 includes information about z-position, ωₓ, and ω_{y}. In some arrangements, the linear velocity of the object in the z-direction ν_{z} may be determined as being approximately equal to ωₓy.

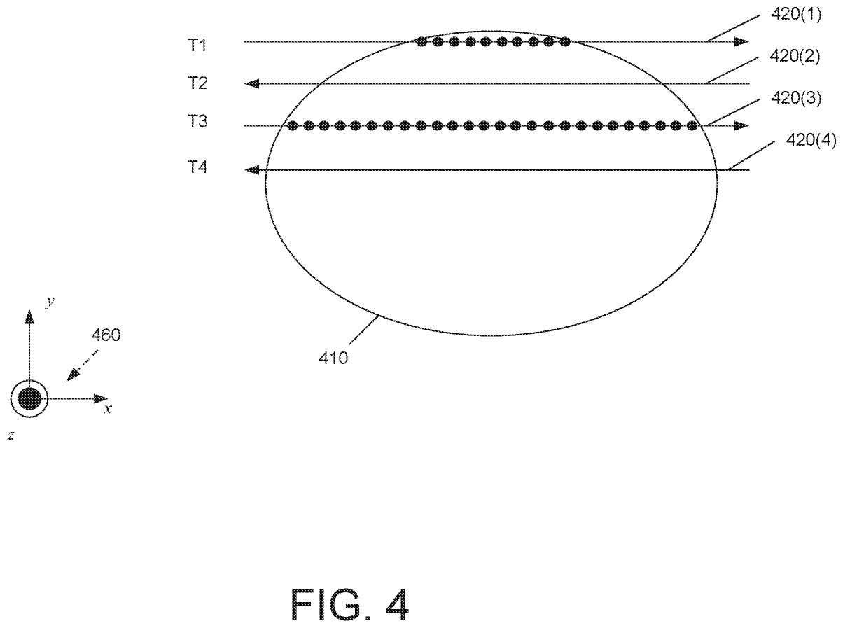

At 308, the tracking system 120 performs a correction operation to produce a correction to the absolute position in the plane of the object at a later time after the initial time, the correction being based on the obtained data. Details of such a correction operation are described with respect to FIGS. 4-6. The correction to the absolute position determined from the video image data 132 provides more accurate 3D position data of the object 110 than processing of the video image data 132 alone.

FIG. 4 illustrates example scan lines 420(1), . . . , 420(4) across an object 410. The scan lines 420(1), . . . , 420(4) are each along the x-direction as defined by the coordinate system 460. Each of the scan lines 420(1), . . . , 420(4) are the result of scans performed by the tracking system 120 in the directions indicated by the arrows. Scan points indicated by the points along the scans 420(1) and 420(3) (which are both the results of scans in the positive x-direction) represent points on the object sampled by the beams 190(1), . . . , 190(N). It is assumed that the scan points on the same scan line, e.g., 420(1), have been sampled at the same time, e.g., T1. It is also assumed that scans which result in different scan lines, e.g., 420(1) and 420(3), are performed at different times, e.g., T1 and T3 as illustrated in FIG. 4.

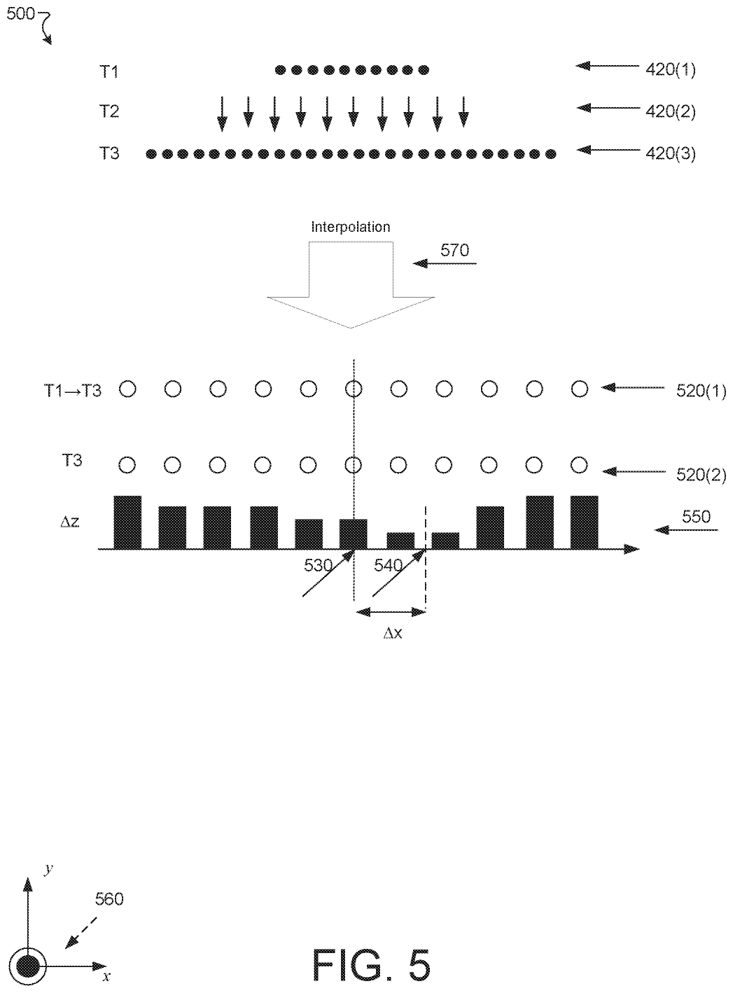

As is illustrated in FIG. 5, the tracking system 120 samples data from scan lines 420(1) and 420(3), i.e., lines scanned in the same direction, to provide a comparison that provides the basis for determining the correction to the absolute position in a plane determined by the video frame image data 132. Scan lines in the same direction such as 420(10 and 420(3) are used for such a comparison of such samples because such samples provide better tracking accuracy than, say, adjacent scan lines 420(1) and 420(2).

FIG. 5 illustrates an example interpolation process used to determine a correction to the x-position of the object 410 (FIG. 4). The scan lines 420(1) and 420(3) as illustrated in FIG. 4 are illustrated without the object 410. In addition, the scan line 420(2) between scan lines 420(1) and 420(3) are shown with arrows indicating a velocity in the z-direction as determined from the LIDAR data, e.g., data from the scan lines 420(1) and 420(3). The times at which the scans that produced the scan lines 420(1), 420(2), and 420(3) are, respectively, T1, T2, and T3, where T1<T2<T3.

The raw LIDAR data received by the detector 180 of the tracking system 120 is not in a form convenient for direct determination of object position. Because the object is typically not uniform in size along, say, the y-direction, the extents of scan lines 420(1) and 420(3) is different. The extents of the scan lines 420(1) and 420(3) are determined simply by the fact that only those beams that are incident on the object 410 will be detected by the detector 180. Further, the sampling may not be uniform and accordingly the LIDAR data points that are received by the tracking system 120 may not be located along a uniform grid.

Accordingly, the position correction manager 144 of the tracking system 120 may perform an interpolation operation 570 on LIDAR data 142 from successive scan lines received by the detector 180. Through such an interpolation operation 570, the position correction manager 144 may then provide a comparison of the deviations as predicted by the object velocity at time T2 determined at the same positions along the x-direction. Such positions are illustrated in FIG. 5 as circles in scan lines 520(1), which corresponds to scan line 420(1), and 520(2), which corresponds to scan line 420(3).

The interpolation operation 570 involves defining a maximum extent of both scan lines 520(1) and 520(2) as the maximum extent of either scan line 420(1) and 420(3) plus or minus a pad length (e.g., 10 pixels). The position correction manager 144 determines the number of interpolation points denoted by the circles in the scan lines 520(1) and 520(2) by specifying an interpolation resolution, e.g., 0.5 pixels. In this way, the position correction manager 144 may define the interpolation points for both scan lines 520(1) and 520(2).

The position correction manager 144 may then begin the process of comparing the differences in the z-positions between the scan lines 520(1) and 520(2) along the scan line 520(2) at each interpolation point. In some arrangements, the position correction manager 144 performs a prediction operation on the raw LIDAR data at scan line 420(1) to produce z-positions in the LIDAR data along scan line 420(1) at time T3 rather than T1. In this case (and the case for the subsequent discussion below), the prediction operation involves estimating the movement along the z-direction based on the velocity ν_{z} in the z-direction. In some implementations, the median velocity in the z-direction is used to determine the adjustment to the z-position at each raw data point along the scan line 420(1). After the position correction manager 144 performs the prediction operation, the position correction manager 144 then performs the interpolation of the z-position data.

With the predicted and actual z-positions at each interpolation point along the scan lines 520(1) and 520(2), the position correction manager 144 may then evaluate the differences in these z-positions 550 to determine the correction to the absolute positions 134 from the video frame image data 132. In some implementations, the correction in the x-positions is determined based on the position along the x-direction in which the difference between predicted and actual z-positions 550 is a minimum.

In some implementations, the position correction manager 144 computes this difference 550 by performing correlation operations between the predicted and actual z-positions at each interpolation point along the scan lines 520(1) and 520(2). Such a correlation operation involves generating a cross-correlation between the predicted and actual z-positions as described above. In some implementations, the predicted and actual z-positions are deviations from a mean predicted z-position.

In some implementations, the position correction manager 144 determines the minimum difference between predicted and actual z-positions 550 by generating a continuous function that produces a difference between a predicted and an actual z-position at each position along the x-direction. In some implementations, the position correction manager 144 generates this continuous function by a quadratic interpolation process in which the continuous function between each of the given points along the scan line 520(2) is assumed to have a quadratic behavior in the x-position.

In some implementations, the x-position determined above is in units of pixels. In this case, the position correction manager 144 produces the correction to the absolute positions 134 from the video frame image data 132 by multiplying this correction by a scale factor that represents the size of a pixel, i.e., 0.5 cm.

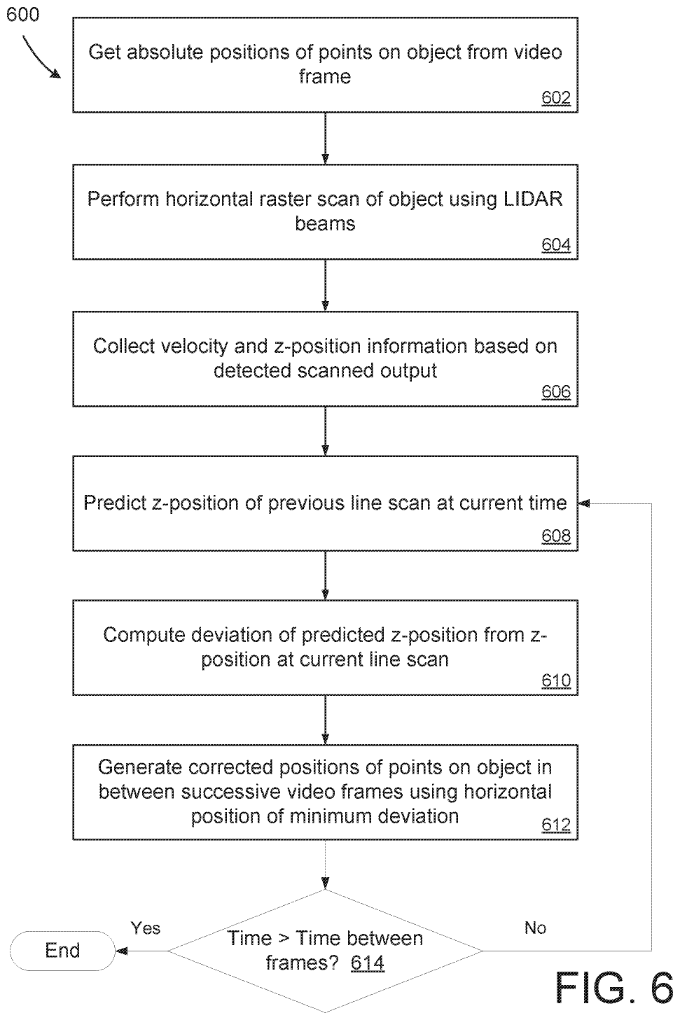

The above computation of the position of the object 410 in space between video frames may be performed multiple times to determine a trajectory of the object 410. Such a computation is illustrated in FIG. 6.

FIG. 6 illustrates an example method 600 of generating a trajectory of the object 410 between successive video frames. The method 600 may be performed by constructs described in connection with FIG. 1, which can reside in memory 126 of the tracking system 120 and can be executed by the processing circuitry 124.

At 602, the tracking system 120 obtains absolute positions of points in a plane of the object 110 from the video frame image data 132, as described above.

At 604, the tracking system 120 performs a horizontal raster scan of the object 110 as described above.

At 606, the tracking system 120 collects velocity and z-position data, i.e., the LIDAR data 142 based on detected scanned output, reflected from the object 110, as described above.

At 608, the tracking system 120 performs a prediction operation on the z-positions of a previous line scan to produce predicted z-positions at the current time, as described above.

At 610, the tracking system 120 computes the deviation of the predicted z-positions at the current time from the actual z-positions at the current time, as described above.

At 612, the tracking system 120 generates corrected positions of points on the object 110 at the current time between successive video frames using the x-position at which the minimum deviation occurs, as described above.

At 614, the tracking system increments the time and determines whether the new time is greater than the time of the next video frame. If so, then the correction operation is complete for the current video frame. If not, then the process 600 returns to 608.

The components (e.g., modules, processors (e.g., a processor defined within a substrate such as a silicon substrate)) of the tracking system 120 (e.g., the position correction manager 144) can be configured to operate based on one or more platforms (e.g., one or more similar or different platforms) that can include one or more types of hardware, software, firmware, operating systems, runtime libraries, and/or so forth. In some implementations, the components of the tracking system 120 can be configured to operate within a cluster of devices (e.g., a server farm).

In some implementations, one or more portions of the components shown in the tracking system 120 in FIG. 1 can be, or can include, a hardware-based module (e.g., a digital signal processor (DSP), a field programmable gate array (FPGA), a memory), a firmware module, and/or a software-based module (e.g., a module of computer code, a set of computer-readable instructions that can be executed at a computer). For example, in some implementations, one or more portions of the tracking system 120 can be, or can include, a software module configured for execution by at least one processor (not shown). In some implementations, the functionality of the components can be included in different modules and/or different components than those shown in FIG. 1.

In some implementations, one or more of the components of the tracking system 120 can be, or can include, processors configured to process instructions stored in a memory. For example, the position correction manager 144 (and/or a portion thereof) can be a combination of a processor and a memory configured to execute instructions related to a process to implement one or more functions.

Although not shown, in some implementations, the components of the tracking system 120 (or portions thereof) can be configured to operate within, for example, a data center (e.g., a cloud computing environment), a computer system, one or more server/host devices, and/or so forth. In some implementations, the components of the tracking system 120 (or portions thereof) can be configured to operate within a network. Thus, the tracking system 120 (or portions thereof) can be configured to function within various types of network environments that can include one or more devices and/or one or more server devices. For example, the network can be, or can include, a local area network (LAN), a wide area network (WAN), and/or so forth. The network can be, or can include, a wireless network and/or wireless network implemented using, for example, gateway devices, bridges, switches, and/or so forth. The network can include one or more segments and/or can have portions based on various protocols such as Internet Protocol (IP) and/or a proprietary protocol. The network can include at least a portion of the Internet.

In some implementations, the tracking system 120 may include a memory. The memory can be any type of memory such as a random-access memory, a disk drive memory, flash memory, and/or so forth. In some implementations, the memory can be implemented as more than one memory component (e.g., more than one RAM component or disk drive memory) associated with the components of the tracking system 120.

In some implementations, a LIDAR system includes a laser system that includes lasers or laser beams that are configured to move in a pattern or patterns with respect to the object that is being tracked. For example, in some implementations, the scanning mechanism 152 of the tracking system 120 includes a plurality of lasers or beams that are configured to move in a pattern or patterns with respect to the object being tracked.

For example, in some implementations, the tracking system 120 may have one mode in which the laser beams are fixed or stationary and a second mode in which the laser beams move in a pattern or patterns such as a shape. In some implementations, two or more of the laser beams move in a pattern or patterns when the tracking system 120 is in the second mode. In some implementations, different laser beams may move independently in different patterns.

In other implementations, the tracking system 120 includes some lasers or produces some laser beams that are stationary and some that are configured to move in a pattern (or patterns) or shape.

The lasers or beams can move in any pattern or shape. For example, in some implementations, the lasers or beams are configured to move in elliptical shape. In other implementations, the lasers or beams are configured to move in a line, circle, square, rectangle, triangle, or any other shape. In some implementations, the shape or pattern that the lasers or beams move in are dictated or determined by the object that is being tracked. For example, in some implementations, the pattern or shape of the laser movement may be similar to the shape of the object that is being tracked. For example, an elliptical shape or pattern may be used when tracking a face of an individual as the face of an individual is generally elliptical in shape.

Implementations of the various techniques described herein may be implemented in digital electronic circuitry, or in computer hardware, firmware, software, or in combinations of them. Implementations may be implemented as a computer program product, i.e., a computer program tangibly embodied in an information carrier, e.g., in a machine-readable storage device (computer-readable medium, a non-transitory computer-readable storage medium, a tangible computer-readable storage medium) or in a propagated signal, for processing by, or to control the operation of, data processing apparatus, e.g., a programmable processor, a computer, or multiple computers. A computer program, such as the computer program(s) described above, can be written in any form of programming language, including compiled or interpreted languages, and can be deployed in any form, including as a stand-alone program or as a module, component, subroutine, or other unit suitable for use in a computing environment. A computer program can be deployed to be processed on one computer or on multiple computers at one site or distributed across multiple sites and interconnected by a communication network.

Method steps may be performed by one or more programmable processors executing a computer program to perform functions by operating on input data and generating output. Method steps also may be performed by, and an apparatus may be implemented as, special purpose logic circuitry, e.g., an FPGA (field programmable gate array) or an ASIC (application-specific integrated circuit).

Processors suitable for the processing of a computer program include, by way of example, both general and special purpose microprocessors, and any one or more processors of any kind of digital computer. Generally, a processor will receive instructions and data from a read-only memory or a random access memory or both. Elements of a computer may include at least one processor for executing instructions and one or more memory devices for storing instructions and data. Generally, a computer also may include, or be operatively coupled to receive data from or transfer data to, or both, one or more mass storage devices for storing data, e.g., magnetic, magneto-optical disks, or optical disks. Information carriers suitable for embodying computer program instructions and data include all forms of non-volatile memory, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory may be supplemented by, or incorporated in special purpose logic circuitry.

To provide for interaction with a user, implementations may be implemented on a computer having a display device, e.g., a liquid crystal display (LCD or LED) monitor, a touchscreen display, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Implementations may be implemented in a computing system that includes a back-end component, e.g., as a data server, or that includes a middleware component, e.g., an application server, or that includes a front-end component, e.g., a client computer having a graphical user interface or a Web browser through which a user can interact with an implementation, or any combination of such back-end, middleware, or front-end components. Components may be interconnected by any form or medium of digital data communication, e.g., a communication network. Examples of communication networks include a local area network (LAN) and a wide area network (WAN), e.g., the Internet.

In some implementations, the tracking system 120 may achieve millimeter range accuracy performance off moving faces of a subject or individual. However, in some implementations, solid object velocity estimation requires processing of multiples samples in order to remove significant velocity components from speech and other biological components. A 500 Hz vibration with an amplitude of 0.05 mm (50 microns) will have a maximum velocity of (2*π*500*5E−5=0.157 m/sec) about 16 cm/sec. Even though the amplitude of the vibration is an insignificant range change for the process of tracking faces of a subject or individual, the instantaneous velocity may be significant and the vibrational velocity may be removed. In some implementations, removing vibrational velocity may require processing a velocity data sample significantly longer than the periods of the vibrations to be removed and care to avoid noise or bias. For example, noise in the velocity (for example, velocity in the z direction) can affect or degrade the ability to detect or determine the rotation of the object or the z velocity of the object. In some implementations, the vibration or velocity noise is relatively small and can be averaged out to remove its effects.

While certain features of the described implementations have been illustrated as described herein, many modifications, substitutions, changes and equivalents will now occur to those skilled in the art. It is, therefore, to be understood that the appended claims are intended to cover all such modifications and changes as fall within the scope of the implementations. It should be understood that they have been presented by way of example only, not limitation, and various changes in form and details may be made. Any portion of the apparatus and/or methods described herein may be combined in any combination, except mutually exclusive combinations. The implementations described herein can include various combinations and/or sub-combinations of the functions, components and/or features of the different implementations described.

What may be claimed is:

1. A method comprising:
receiving, by processing circuitry, a video frame including (i) an image of an object located at an absolute position in a plane and (ii) a timestamp indicating an initial time at which the object was located at the absolute position in the plane;
scanning, by the processing circuitry, a set of beams of electromagnetic radiation in lines over the object;
obtaining, by the processing circuitry, data indicating a velocity of the object and position of the object out of the plane as the beam of electromagnetic radiation is scanned over the object;
performing, by the processing circuitry, a correction operation to produce a correction to the absolute position in the plane of the object at a later time after the initial time, the correction being based on the obtained data.

2. The method as in claim 1,
wherein scanning the beam of electromagnetic radiation in lines over the object includes:
performing a first line scan in a first direction in the plane at a first time after the initial time;
performing a second line scan at a position normal to the first scan line in the plane, in a second direction at a second time, the second direction being opposite to the first direction; and
performing a third line scan at a position normal to the second line scan, in the first direction at a third time.

3. The method as in claim 2,
wherein performing the correction operation includes:
performing a prediction operation on the first line scan to produce a predicted third line scan at the third time;
generating differences in position normal to the plane between points on the third line scan at the third time and a point on the predicted third line scan at the third time; and
producing, as the correction, the position along the first direction at which a difference in position along the beam direction is optimal.

4. The method as in claim 3,
wherein producing the position along the first direction at which a difference in position normal to the plane is optimal includes:
performing an interpolation operation on the differences in position normal to the plane between points on the third line scan at the third time and a point on the predicted third line scan at the third time to produce a minimum difference and a position along the first direction at which the minimum difference is achieved.

5. The method as in claim 3,
wherein performing the prediction operation includes:
producing a rotational speed of the object at a point on the first line scan normal to the plane;
generating a speed of the object at the point on the first line scan along the first direction based on the rotational speed of the object at the point; and
producing, as a point on the predicted third line scan, a sum of a position of the point on the first line scan plus a correction based on the speed of the object and a difference between the first time and the third time.

6. The method as in claim 1, further comprising:
at a new time after the later time, receiving another video frame including (i) another image of an object located at another absolute position in another plane and (ii) a timestamp indicating the new time at which the object was located at the other absolute position in the other plane; and
forming a trajectory of the object in space based on the positions of the object at the at the initial time, the later time, and the new time.

7. A computer program product comprising a nontransitory storage medium, the computer program product including code that, when executed by processing circuitry of a computer, causes the processing circuitry to perform a method, the method comprising:
receiving a video frame including (i) an image of an object located at an absolute position in a plane and (ii) a timestamp indicating an initial time at which the object was located at the absolute position in the plane;
scanning a set of beams of electromagnetic radiation in lines over the object;
obtaining data indicating data indicating a velocity of the object and position of the object out of the plane as the beam of electromagnetic radiation is scanned over the object;
performing a correction operation to produce a correction to the absolute position in the plane of the object at a later time after the initial time, the correction being based on the obtained data.

8. The computer program product as in claim 7,
wherein scanning the beam of electromagnetic radiation in lines over the object includes:
performing a first line scan in a first direction in the plane at a first time after the initial time;
performing a second line scan at a position normal to the first scan line in the plane, in a second direction at a second time, the second direction being opposite to the first direction; and
performing a third line scan at a position normal to the second line scan, in the first direction at a third time.

9. The computer program product as in claim 8,
wherein performing the correction operation includes:
performing a prediction operation on the first line scan to produce a predicted third line scan at the third time;
generating differences in position normal to the plane between points on the third line scan at the third time and a point on the predicted third line scan at the third time; and
producing, as the correction, the position along the first direction at which a difference in position along the beam direction is optimal.

10. The computer program product as in claim 9,
wherein producing the position along the first direction at which a difference in position normal to the plane is optimal includes:
performing an interpolation operation on the differences in position normal to the plane between points on the third line scan at the third time and a point on the predicted third line scan at the third time to produce a minimum difference and a position along the first direction at which the minimum difference is achieved.

11. The computer program product as in claim 9,
wherein performing the prediction operation includes:
producing a rotational speed of the object at a point on the first line scan normal to the plane;
generating a speed of the object at the point on the first line scan along the first direction based on the rotational speed of the object at the point; and
producing, as a point on the predicted third line scan, a sum of a position of the point on the first line scan plus a correction based on the speed of the object and a difference between the first time and the third time.

12. The computer program product as in claim 7, wherein the method further comprises:
at a new time after the later time, receiving another video frame including (i) another image of an object located at another absolute position in another plane and (ii) a timestamp indicating the new time at which the object was located at the other absolute position in the other plane; and
forming a trajectory of the object in space based on the positions of the object at the at the initial time, the later time, and the new time.

13. An electronic apparatus, comprising:
memory; and
controlling circuitry coupled to the memory, the controlling circuitry being configured to:
receive a video frame including (i) an image of an object located at an absolute position in a plane and (ii) a timestamp indicating an initial time at which the object was located at the absolute position in the plane;
scan a set of beams of electromagnetic radiation in lines over the object;
obtain data indicating data indicating a velocity of the object and position of the object out of the plane as the beam of electromagnetic radiation is scanned over the object;
perform a correction operation to produce a correction to the absolute position in the plane of the object at a later time after the initial time, the correction being based on the obtained data.

14. The electronic apparatus as in claim 13,
wherein the controlling circuitry configured to scan the beam of electromagnetic radiation in lines over the object is further configured to:
perform a first line scan in a first direction in the plane at a first time after the initial time;
perform a second line scan at a position normal to the first scan line in the plane, in a second direction at a second time, the second direction being opposite to the first direction; and
perform a third line scan at a position normal to the second line scan, in the first direction at a third time.

15. The electronic apparatus as in claim 14,
wherein the controlling circuitry configured to perform the correction operation is further configured to:
perform a prediction operation on the first line scan to produce a predicted third line scan at the third time;
generate differences in position normal to the plane between points on the third line scan at the third time and a point on the predicted third line scan at the third time; and
produce, as the correction, the position along the first direction at which a difference in position along the beam direction is optimal.

16. The electronic apparatus as in claim 15,
wherein the controlling circuitry configured to produce the position along the first direction at which a difference in position normal to the plane is optimal is further configured to:
perform an interpolation operation on the differences in position normal to the plane between points on the third line scan at the third time and a point on the predicted third line scan at the third time to produce a minimum difference and a position along the first direction at which the minimum difference is achieved.

17. The electronic apparatus as in claim 15,
wherein the controlling circuitry configured to perform the prediction operation is further configured to:
produce a rotational speed of the object at a point on the first line scan normal to the plane;
generate a speed of the object at the point on the first line scan along the first direction based on the rotational speed of the object at the point; and
produce, as a point on the predicted third line scan, a sum of a position of the point on the first line scan plus a correction based on the speed of the object and a difference between the first time and the third time.

18. The electronic apparatus as in claim 13, wherein the controlling circuitry is further configured to:
at a new time after the later time, receive another video frame including (i) another image of an object located at another absolute position in another plane and (ii) a timestamp indicating the new time at which the object was located at the other absolute position in the other plane; and
form a trajectory of the object in space based on the positions of the object at the at the initial time, the later time, and the new time.
